(19) United States
(12) Patent Application Publication
(10) Pub. No.: US 2009/0170379 A1
(43) Pub. Date: Jul. 2, 2009

(54) CLIP FOR CONNECTION TO A STAB TERMINAL OF AN ELECTRICAL BUSS AND ASSOCIATED METHODS

(76) Inventors: Stanley F. Allina, JR., North Palm Beach, FL (US); Larry G. Tinker, Tulsa, OK (US)

Correspondence Address: GREENBERG TRAURIG, LLP, MET LIFE BUILDING, 200 PARK AVENUE, NEW YORK, NY, 10166, US

(21) Appl. No.: 11/965,881

(22) Filed: Dec. 28, 2007

(51) Int. Cl. H01R 4/48; H01R 33/00

(52) U.S. Cl. 439/861; 439/660

(57) ABSTRACT

One embodiment of the present invention relates to a clip for making an electrical connection with a buss stab terminal, comprising: a generally flat body having a first side and a second side and being formed at least in part from an electrically conductive material; an elongated slot in the body; a first spring flap adjacent the slot, wherein the first spring flap projects at least partially outward, away from the body on the first side of the body; and a second spring flap adjacent the slot, wherein the second spring flap projects at least partially outward, away from the body on the first side of the body and wherein the second spring flap is on the opposite side of the slot relative to the first spring flap; wherein the clip is configured to slide onto the buss stab terminal (such as an electric meter) by receiving the buss stab terminal through the slot; and wherein the spring flaps apply pressure to the buss stab terminal to provide an electrical connection between the buss stab terminal and the clip. In one specific example, the clip may be a free-floating, housing-less clip.

### FIELD OF THE INVENTION

One embodiment of the present invention relates to a clip for connection (e.g., a removable connection) to an electrical buss (e.g., a watt-hour meter buss stab).

Another embodiment of the present invention relates to a method of using a clip for connection (e.g., a removable connection) to an electrical buss (e.g., a watt-hour meter buss stab).

Another embodiment of the present invention relates to a method of making a clip for connection (e.g., a removable connection) to an electrical buss (e.g., a watt-hour meter buss stab).

For the purposes of describing and claiming the present invention the term “spring flap” is intended to refer to a component that may be deflected in a first direction in response to the application of a force and then applies its own biasing force in a second direction that is essentially opposite to the first direction.

Further, for the purposes of describing and claiming the present invention the term “relief” is intended to refer to an indentation, hole, or other void.

Further still, for the purposes of describing and claiming the present invention the term “buss or stab terminal” (e.g., buss stab terminal of an electric meter) is intended to refer to a male electrical terminal.

### BACKGROUND OF THE INVENTION

Very few conventional mechanisms exist to make an electrical connection at an electric meter, such as for the purpose of attaching auxiliary equipment. It is believed, however, the few conventional mechanisms available are typically costly, cumbersome and/or may potentially violate electrical codes.

One particular conventional manner of interposing an electrical connection between an electric meter and an associated meter pan (can) is comprised of a device referred to as an “extension housing”. Such a device extends the electric meter about 1 to 4 inches and has housed within one or more extension bus bars. This device is typically costly, cumbersome and can potentially reduce (de-rate) the current handling capacity of the entire interconnection.

Another conventional methodology involves an insulation piercing device which typically requires tooling to install and is typically cumbersome and costly (it is believed that this method, however, does not typically de-rate the capacity of the connections).

Yet another conventional methodology related to making a connection is to loosen an existing connection and insert a second conductor into the connection. Although believed to be routinely practiced, this method (known as “double lugging”) is believed not allowed by many local codes and believed not recommended in the National Electrical Code. Code interpretations do, however, vary from place to place and from individual to individual.

And yet another methodology relating to making a connection is to drill and attach a fastener, such as a bolt, to existing buss material. In the interpretation of acceptability this method may be equally as unacceptable as double lugging.

### BRIEF DESCRIPTION OF THE DRAWINGS

FIGS. 1A-1D show various views of a clip according to an embodiment of the present invention (FIG. 1A shows a plan view of the clip; FIG. 1B shows a side view of the clip; FIG. 1C shows an end view of the clip; and FIG. 1D shows a perspective view of the clip (from the opposite side of that shown in FIG. 1A);

FIGS. 2A-2C show various views of a clip according to an another embodiment of the present invention (FIG. 2A shows a plan view of the clip; FIG. 2B shows a side view of the clip; and FIG. 2C shows an end view of the clip);

FIG. 3 shows a plan view of a clip according to an another embodiment of the present invention;

FIGS. 4A and 4B show various views of a prototype die (FIG. 4A) for forming a clip and a plan view of a portion of a resulting clip (FIG. 4B) according to another embodiment of the present invention; and

FIGS. 5A-5C show various views of a clip according to another embodiment of the present invention (FIG. 5A shows a plan view of the clip; FIG. 5B shows a side view of the clip; and FIG. 5C shows an end view of the clip).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, any figures are not necessarily to scale, some features may be exaggerated to show details of particular components. In addition, any measurements, specifications, company names and the like are intended to be illustrative, and not restrictive. Therefore, specific structural and functional details disclosed herein are not to be interpreted as limiting, but merely as a representative basis for teaching one skilled in the art to variously employ the present invention.

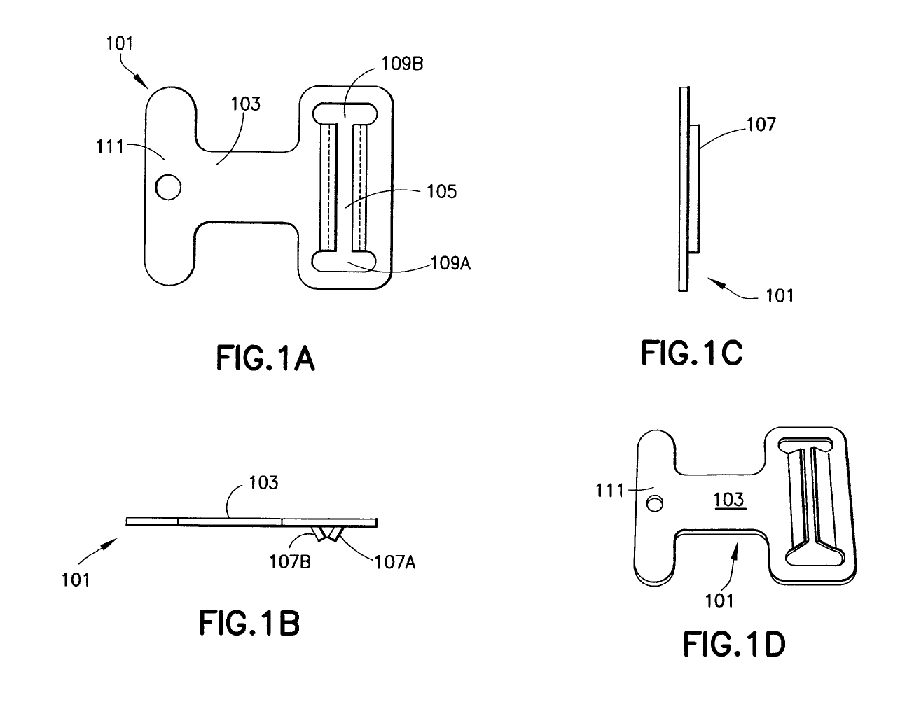

Reference will now be made to FIGS. 1A-1D, showing one embodiment of the present invention. As seen in these FIGS., a clip for making an electrical connection (e.g., with a buss stab terminal) may be provided. The clip 101 may comprise a generally flat body 103 having a first side and a second side and may be formed at least in part from an electrically conductive material. There may be an elongated slot 105 in the body 103. A first spring flap 107A may be disposed adjacent the slot 105, wherein the first spring flap 107A projects at least partially outward, away from the body 103 on the first side of the body. In addition, there may be a second spring flap 107B adjacent the slot 105, wherein the second spring flap 107B projects at least partially outward, away from the body 103 on the first side of the body (as seen, the second spring flap 107B may be on the opposite side of the slot 105 relative to the first spring flap 107A).

Of note, the clip 101 may be configured to slide onto a buss stab terminal such as an electric meter (not shown) by receiving the buss stab terminal through the slot 105 and the spring flaps 107A, 107B may apply pressure to the buss stab terminal to provide an electrical and/or mechanical connection between the buss stab terminal and the clip 101.

In one example, the body 103 may be formed entirely from any ferrous and/or non-ferrous electrically conductive material.

In another example, the electrically conductive material may be spring temper, electrically conductive material.

In another example, the electrically conductive material may be selected from the group including (but not limited to): phosphorus bronze, beryllium copper, stainless steel, brass, and steel.

In another example, the thickness of the body 103 may be about 20 gauge (about 0.032″). Of note, this thickness closely corresponds with the material thickness used as the industry standard for typical slide-on connectors. Other thicknesses can, however, be utilized depending on application.

In another example, a length of the slot may be about 0.25 to 4″. Other lengths can, however, be utilized depending on application.

In another example, at least one relief 109A may be provided in the body 103, the relief being provided at one end of the slot 105. In another example, a first relief 109A and a second relief 109B (together forming a “dog bone” configuration with the slot 105) may be provided in the body, the first relief 109A being provided at a first end of the slot 105 and the second relief 109B being provided at a second end of the slot 105. Of note, the spring flap(s) may help provide for a positive yet variable contact with the buss stab terminal on the flat surface where thickness can vary. In this example, the dog bone relief(s) may be crucial and help provide for flex and/or lateral movement (e.g., to accommodate for dimensional variations in the opposite direction).

In another example, the first spring flap 107A may be integral with the body 103 and the second spring flap 107B may be integral with the body 103.

In another example, the first spring flap 107A may project away from the body 103 in a non-orthogonal direction and the second spring flap 107B may project away from the body 103 in a non-orthogonal direction.

In another example, the first spring flap 107A may project away from the body 103 in a non-orthogonal direction towards the second spring flap 107B and the second spring flap 107B may project away from the body 103 in a non-orthogonal direction towards the first spring flap 107A (see, e.g., FIG. 1B).

In another example, the body 103 may further comprise an interconnect portion 111 configured to interconnect with a wire conductor (not shown). Of note, in the example shown in this FIG., interconnect portion 111 is a T-shaped connector, which allows the clip 101 to be used in either the right hand or left hand position. Of course, other shapes may be utilized as desired. Of further note, mechanisms for interconnecting interconnect portion 111 to a wire conductor may include (but not be limited to): a standard slide-on electrical connector, solder-on, rivet-on, bolt-on, or any combination thereof.

In another example, the clip may be a free-floating, housing-less clip.

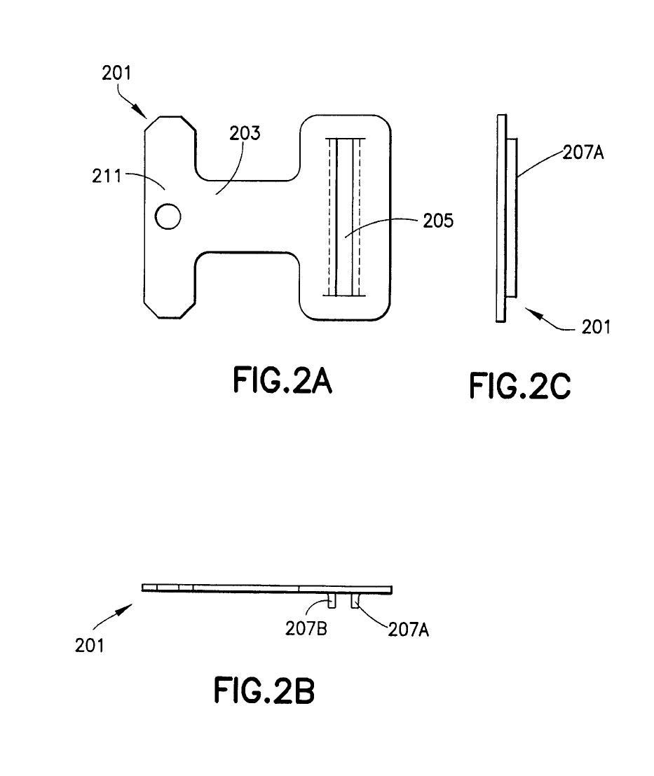

With reference now to FIGS. 2A-2C, another embodiment of the present invention is shown. This embodiment is similar to the embodiment of FIGS. 1A-1D in that the clip 201 may comprise a generally flat body 203 having a first side and a second side and may be formed at least in part from an electrically conductive material. There may be an elongated slot 205 in the body 203. A first spring flap 207A may be disposed adjacent the slot 205, wherein the first spring flap 207A projects at least partially outward, away from the body 203 on the first side of the body. In addition, there may be a second spring flap 207B adjacent the slot 205, wherein the second spring flap 207B projects at least partially outward, away from the body 203 on the first side of the body (as seen, the second spring flap 207B may be on the opposite side of the slot 205 relative to the first spring flap 207A). Of note, while first spring flap 207A and second spring flap 207B are shown generally parallel in these FIGS., in operation the first spring flap 207A and second spring flap 207B would typically be tilted towards one another in order to make contact with the stab terminal. In addition, the body 203 may further comprise an interconnect portion 211 configured to interconnect with a wire conductor (not shown), as discussed above. Of note, two main distinctions between the clip of these FIGS. 2A-2C and the clip of FIGS. 1A-1D are that in these FIGS. 2A-2C there is no relief adjacent either end of the slot 205 and the interconnect portion 211 has planar, rather than rounded ends.

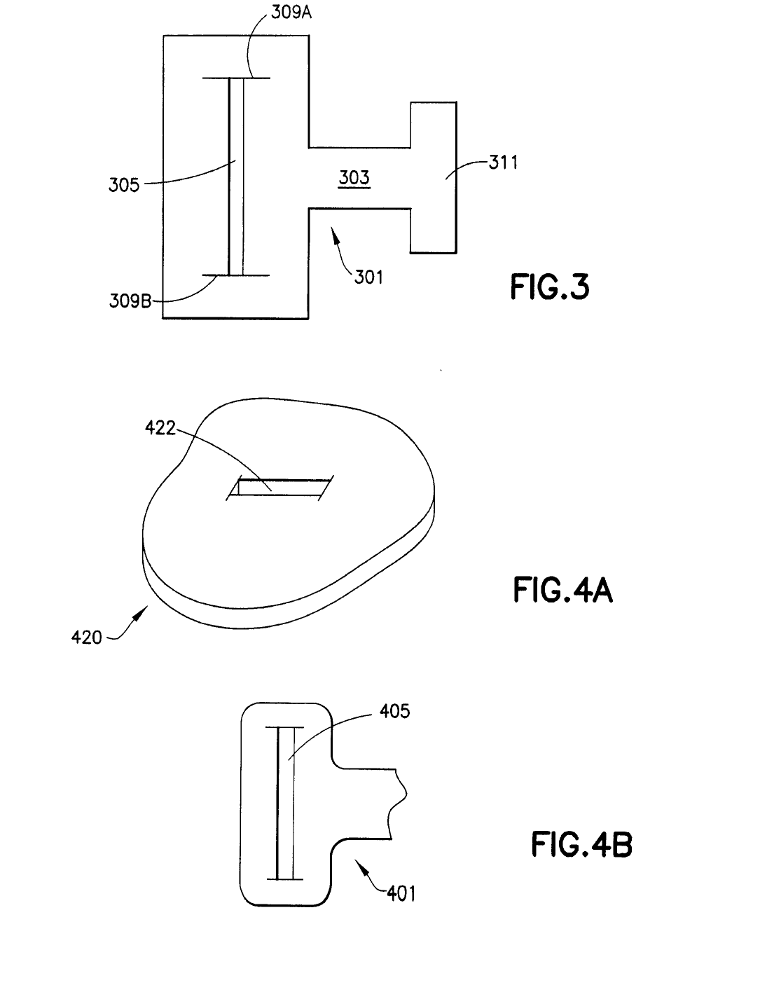

With reference now to FIG. 3, another embodiment of the present invention is shown. This embodiment is similar to the embodiment of FIGS. 1A-1D in that the clip 301 may comprise a generally flat body 303 having a first side and a second side and may be formed at least in part from an electrically conductive material. There may be an elongated slot 305 in the body 303. A first spring flap may be disposed adjacent the slot 305, wherein the first spring flap projects at least partially outward, away from the body 303 on the first side of the body. In addition, there may be a second spring flap adjacent the slot 305, wherein the second spring flap projects at least partially outward, away from the body 303 on the first side of the body (the second spring flap may be on the opposite side of the slot 305 relative to the first spring flap). In addition, the body 303 may further comprise an interconnect portion 311 configured to interconnect with a wire conductor (not shown), as discussed above. Of note, two main distinctions between the clip of this FIG. 3 and the clip of FIGS. 1A-1D are that in this FIG. 3 there is no relief adjacent either end of the slot 305 (in this example there are slits 309A,309B instead) and the interconnect portion 311 has planar, rather than rounded ends.

With reference now to FIGS. 4A and 4B, a prototype die (FIG. 4A) for forming the slot 105, 205 and 305 in a clip and a plan view of a portion of a resulting clip (FIG. 4B) according to another embodiment of the present invention are shown. More particularly, die 420 (the punch portion is not shown but which would closely replicate the dimension of the receiving buss and incorporate some form of conical or knife like edge) may include aperture 422 for forming a clip slot such as described herein (a portion of clip 401 showing slot 405 is provided in FIG. 4B as an example). Of course, various methods for making the devices described herein (e.g., such as by stamping and/or other means) are intended to comprise part of the present invention.

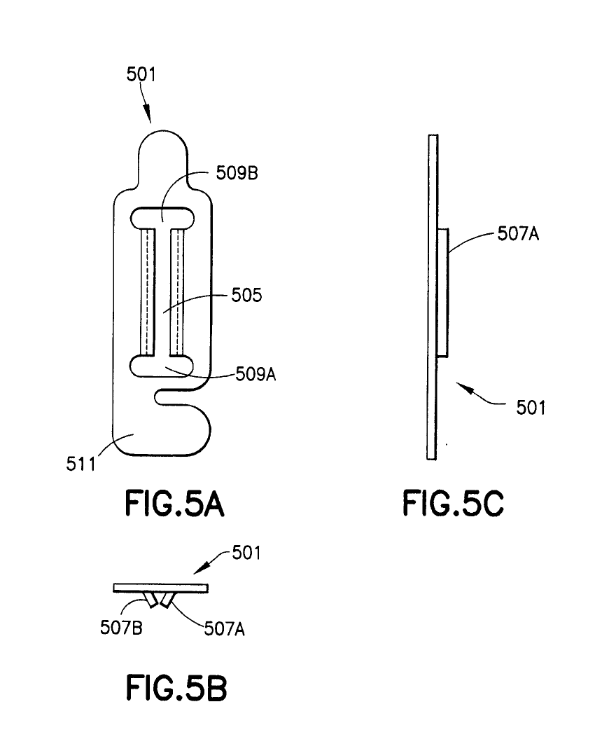

With reference now to FIGS. 5A-5C, another embodiment of the present invention is shown. This embodiment is similar to the embodiment of FIGS. 1A-1D in that the clip 501 may comprise a generally flat body 503 having a first side and a second side and may be formed at least in part from an electrically conductive material. There may be an elongated slot 505 in the body 503. A first spring flap 507A may be disposed adjacent the slot 505, wherein the first spring flap 507A projects at least partially outward, away from the body 503 on the first side of the body. In addition, there may be a second spring flap 507B adjacent the slot 505, wherein the second spring flap 507B projects at least partially outward, away from the body 503 on the first side of the body (as seen, the second spring flap 507B may be on the opposite side of the slot 505 relative to the first spring flap 507A). In addition, the body 503 may further comprise an interconnect portion 511 configured to interconnect with a wire conductor (not shown), as discussed above. Of note, this thinner design may be used in connection with electric meters where the stab terminals are in close proximity to one another (e.g., three phase electric meters).

In another embodiment, a method of making an electrical connection (e.g., with a buss stab terminal) is provided, comprising: providing a clip with a generally flat body having a first side and a second side, the body being formed at least in part from an electrically conductive material, the body having an elongated slot therein, a first spring flap being disposed adjacent the slot, wherein the first spring flap projects at least partially outward, away from the body on the first side of the body, and a second spring flap being disposed adjacent the slot, wherein the second spring flap projects at least partially outward, away from the body on the first side of the body and wherein the second spring flap is on the opposite side of the slot relative to the first spring flap; and sliding the clip onto the buss stab terminal by receiving the buss stab terminal through the slot; wherein the spring flaps apply pressure to the buss stab terminal to provide an electrical connection between the buss stab terminal and the clip.

In another embodiment, a clip for making an electrical connection (e.g., with a buss stab terminal) is provided, comprising: a generally flat body having a first side and a second side and being formed at least in part from an electrically conductive material; an elongated slot in the body; and at least one spring flap adjacent the slot, wherein the spring flap projects at least partially outward, away from the body on the first side of the body; wherein the clip is configured to slide onto the buss stab terminal by receiving the buss stab terminal through the slot; and wherein the spring flap applies pressure to the buss stab terminal to provide an electrical connection between the buss stab terminal and the clip.

In another embodiment, a method of making an electrical connection (e.g., with a buss stab terminal) is provided, comprising: providing a clip with a generally flat body having a first side and a second side, the body being formed at least in part from an electrically conductive material, the body having an elongated slot therein, and at least one spring flap being disposed adjacent the slot, wherein the spring flap projects at least partially outward, away from the body on the first side of the body; and sliding the clip onto the buss stab terminal by receiving the buss stab terminal through the slot; wherein the spring flap applies pressure to the buss stab terminal to provide an electrical connection between the buss stab terminal and the clip.

As described herein, various embodiments of the present invention may provide a device (and associated method) that is easily installed, inexpensive and/or will not de-rate the current rating of the interconnection.

Further, as described herein, various embodiments of the present invention may provide a mechanism for making a very low profile electrical connection to one or more stab terminals on the rear of an electric meter (in one example, the electrical connections may be electrically sound, essentially universal in their application, quick to install, economical, reusable or disposable, and/or do not interfere with the electrical and/or mechanical function of the electric meter).

Further still, as described herein, various embodiments of the present invention may provide for ease of installation by use of a push-on design. In one example, no special tools would be required for such push-on installation. In another example, no tools at all would be required for such push-on installation.

Further still, as described herein, various embodiments of the present invention may provide for minor dimensional variations between buss stab terminals (such dimensional variation may be provided for by the spring flap(s) and/or relief(s) described above). While a number of embodiments of the present invention have been described, it is understood that these embodiments are illustrative only, and not restrictive, and that many modifications may become apparent to those of ordinary skill in the art. For example, the clip may be bare, plated, insulated or any combination thereof. Further, the clip may be used for a variety of electrical applications including, but not limited to: test equipment hookup, temporary electrical connection, operating machinery, surge protection). Further still, the clip may be of any desired shape (see, e.g., the symmetric plan view shape of FIG. 1 and the asymmetric plan view shape of FIG. 5). Further still, the clip may electrically conductive and capable of withstanding significant electrical impulses. Further still, the clip may electrically conductive and capable of conducting a wide range of continuous current (e.g., starting at micro amps (such as in connection with test equipment) and moving up to 50 or more amps (such as in connection with heavy loads). Further still, the clip, or a portion thereof, can be affixed to a circuit board or like material. Further still, any steps relating to manufacture and/or use may be performed in any desired order (and any desired steps may be deleted and/or any desired steps may be added).

1. A clip for making an electrical connection with a buss stab terminal of a watt-hour meter, comprising:
a generally flat body having a first side and a second side and being formed at least in part from an electrically conductive material;
an elongated slot in the body;
a first spring flap adjacent the slot, wherein the first spring flap projects at least partially outward, away from the body on the first side of the body; and
a second spring flap adjacent the slot, wherein the second spring flap projects at least partially outward, away from the body on the first side of the body and wherein the second spring flap is on the opposite side of the slot relative to the first spring flap;
wherein the clip is configured to slide onto the buss stab terminal of the watt-hour meter by receiving the buss stab terminal of the watt-hour meter through the slot;
wherein the spring flaps apply pressure to the buss stab terminal of the watt-hour meter to provide an electrical connection between the buss stab terminal of the watt-hour meter and the clip; and
wherein the body further comprises a portion configured to interconnect to a wire conductor via a slide-on electrical connector.

2. The clip of claim 1, wherein the body is formed entirely from an electrically conductive material.

3. The clip of claim 2, wherein the electrically conductive material is spring temper, electrically conductive material.

4. The clip of claim 2, wherein the electrically conductive material is selected from the group consisting of: phosphorus bronze, beryllium copper, stainless steel, brass, and steel.

5. The clip of claim 1, wherein a thickness of the body is about 0.010 to 0.065″.

6. The clip of claim 1, wherein at least one relief is provided in the body, the relief being provided at one end of the slot.

7. The clip of claim 1, wherein a first relief and a second relief are provided in the body, the first relief being provided at a first end of the slot and the second relief being provided at a second end of the slot.

8. The clip of claim 1, wherein the first spring flap is integral with the body and the second spring flap is integral with the body.

9. The clip of claim 1, wherein the first spring flap projects away from the body in a non-orthogonal direction and wherein the second spring flap projects away from the body in a non-orthogonal direction.

10. The clip of claim 1, wherein the first spring flap projects away from the body in a non-orthogonal direction towards the second spring flap and wherein the second spring flap projects away from the body in a non-orthogonal direction towards the first spring flap.

11. (canceled)

12. The clip of claim 1, wherein the clip is a free-floating, removable, housing-less clip.

13. The clip of claim 1, wherein a length of the slot is about 0.25 to 4″.

14. A method of making an electrical connection with a buss stab terminal of a watt-hour meter, comprising:
providing a clip with a generally flat body having a first side and a second side, the body being formed at least in part from an electrically conductive material, the body having an elongated slot therein, a first spring flap being disposed adjacent the slot, wherein the first spring flap projects at least partially outward, away from the body on the first side of the body, and a second spring flap being disposed adjacent the slot, wherein the second spring flap projects at least partially outward, away from the body on the first side of the body, wherein the second spring flap is on the opposite side of the slot relative to the first spring flap and wherein the body further comprises a portion configured to interconnect to a wire conductor via a slide-on electrical connector; and
sliding the clip onto the buss stab terminal of the watt-hour meter by receiving the buss stab terminal of the watt-hour meter through the slot;
wherein the spring flaps apply pressure to the buss stab terminal of the watt-hour meter to provide an electrical connection between the buss stab terminal of the watt-hour meter and the clip.

15. The method of claim 14, wherein the clip is a free-floating, removable, housing-less clip.

16. A clip for making an electrical connection with a buss stab terminal of a watt-hour meter, comprising:
a generally flat body having a first side and a second side and being formed at least in part from an electrically conductive material;
an elongated slot in the body; and
at least one spring flap adjacent the slot, wherein the spring flap projects at least partially outward, away from the body on the first side of the body;
wherein the clip is configured to slide onto the buss stab terminal of the watt-hour meter by receiving the buss stab terminal of the watt-hour meter through the slot;
wherein the spring flap applies pressure to the buss stab terminal of the watt-hour meter to provide an electrical connection between the buss stab terminal of the watt-hour meter and the clip; and
wherein the body further comprises a portion configured to interconnect to a wire conductor via a slide-on electrical connector.

17. The clip of claim 16, wherein the clip is a free-floating, removable, housing-less clip.

18. A method of making an electrical connection with a buss stab terminal of a watt-hour meter, comprising:
providing a clip with a generally flat body having a first side and a second side, the body being formed at least in part from an electrically conductive material, the body having an elongated slot therein, and at least one spring flap being disposed adjacent the slot, wherein the spring flap projects at least partially outward, away from the body on the first side of the body and wherein the body further comprises a portion configured to interconnect to a wire conductor via a slide-on electrical connector; and
sliding the clip onto the buss stab terminal of the watt-hour meter by receiving the buss stab terminal of the watt-hour meter through the slot;
wherein the spring flap applies pressure to the buss stab terminal of the watt-hour meter to provide an electrical connection between the buss stab terminal of the watt-hour meter and the clip.

19. The method of claim 18, wherein the clip is a free-floating, removable, housing-less clip.
